(19) United States
(12) Patent Application Publication
(10) Pub. No.: US 2014/0265751 A1
(43) Pub. Date: Sep. 18, 2014

(54) ELECTRIC MOTOR

(71) Applicant: Flux Energy Systems, LLC, Atoka, OK (US)

(72) Inventor: Lucian L. Ellzey, JR., Norman, OK (US)

(73) Assignee: Flux Energy Systems, LLC, Atoka, OK (US)

(21) Appl. No.: 14/213,234

(22) Filed: Mar. 14, 2014

Related U.S. Application Data
(60) Provisional application No. 61/793,348, filed on Mar. 15, 2013.

(51) Int. Cl. H02K 1/27; H02K 11/00

(52) U.S. Cl. CPC H02K 1/27; H02K 11/0073
USPC 310/68 R; 310/156.01

(57) ABSTRACT

An electric motor comprises a stator assembly having at least two armature coils, and a rotor assembly arranged radially inward of the stator assembly. The rotor assembly has a rotor core, a magnetic ring, and a plurality of permanent magnets. The rotor core is substantially cylindrical in shape and constructed of a diamagnetic material. The magnetic ring is positioned about the rotor core, and the permanent magnets are positioned in the magnetic ring in such a way that magnetic fields created by the armature coils provide an attractive force which selectively attracts the permanent magnets toward the armature coils so as to impart rotational mechanical energy to the rotor assembly.

### CROSS-REFERENCE TO RELATED APPLICATIONS

This application claims priority to U.S. provisional application Ser. No. 61/793,348, filed on Mar. 15, 2013, the entire disclosure of which is hereby expressly incorporated herein by reference.

### BACKGROUND

Electric motors are well known in the art, and multiple attempts have been made to increase the efficiency of such electric motors. Electric motors generally include a stationary part called a stator having armature windings therein, and a moving part called a rotor which rotates relative to the stator. The stator and the rotor of electric motors use the electromagnetic repulsion or attraction between opposing pairs of magnets and coils separated by an air gap to generate rotational motion by typically supplying current to the coils so that the resulting electromagnetic field pushes or pulls on the magnets to generate rotational movement of the rotor. Some electric motors use permanent magnets, and some electric motors use electromagnets.

With electric motors being found in products ranging from toothbrushes to heavy industrial machines, they have become ubiquitous. Nevertheless, a constant search still exists for ways to maximize the efficiency and reduce the price of electric motors. For example, recent International Electrotechnical Commission standards establish minimum efficiency standards for several classes of electric motors for new electric motors manufactured after Jan. 1, 2015. The recent emergence of hybrid and electric vehicles has made the quest for more efficient electric motors the focus of private and government-sponsored research and development to the tune of millions of U.S. dollars per year.

Existing electric motors have several inherent inefficiencies and problems. For example, existing electric motors utilize relatively large amounts of electrical current supplied to coils. The relative large current supplied to the coils of existing electric motors is subject to electrical resistance in the coils according to Joule's first law which states that the energy lost increases as the square of the current through the windings, and in proportion to the electrical resistance of the conductors in the windings. This loss is termed winding loss (“I squared R loss” or “I²R loss”), and results in a significant power loss and a relatively large amount of heat being generated by existing electric motors. This relatively large amount of heat, if left unchecked, may cause electric motors to overheat and/or demagnetization of the magnets. To account for the resistive heat generation by the coils, existing electric motors incorporate cooling devices such as heat sinks or air fans, which further reduce the efficiency and increase the cost of existing electric motors. A large portion of the energy of the current is converted to heat, rather than to mechanical energy.

Accordingly, a need exists for an electric motor configured to maximize efficiency, while minimizing cost, power input, and heat generation. It is to such an electric motor that the inventive concepts disclosed herein are directed.

### SUMMARY

Generally, but not by way of limitation, the inventive concepts disclosed herein are directed to an electric motor of the permanent magnet type. More particularly, but not by way of limitation, the inventive concepts disclosed herein are directed to permanent magnet electric motors and to a method of focusing the power of permanent magnets as the primary power source of an electric motor by reducing the length of the flux path and reducing other magnetic interferences. Relatively low power input to the coils is used primarily to release the potential energy of the permanent magnets and as a speed-control to control the speed of the electric motor.

In an exemplary embodiment, the electric motor has a substantially cylindrical rotor which includes a diamagnetic core having a cylindrical magnetic ring (e.g., a magnetic ring) on its periphery, into which magnetic ring at least two, or a plurality of permanent magnets are embedded so that the permanent magnets are spaced a distance from one another and are oriented substantially parallel to an axis of rotation of the rotor. The surfaces of the permanent magnets are positioned on an axial surface of the magnetic ring. An air gap separates the surfaces of the permanent magnets from a substantially cylindrical stator having a plurality of windings or coils integrated therein. The rotor core and the magnetic ring cooperate to focus the magnetic flux of the permanent magnets by reducing the length of the flux path (e.g., by directing the flux or fluctuating magnetic field of the permanent magnets away from the rotor core), thus allows the permanent magnets to serve as the primary power source for the electric motor. Consequently, a relatively low-power input is provided to the coils to operate the electric motor.

In some exemplary embodiments, an electric motor according to the inventive concepts disclosed herein may include a stator having at least two armature coils arranged on an inner periphery of the stator. The electric motor also has a rotor arranged radially inward the stator and separated from the stator by an air gap, the rotor including a diamagnetic rotor core having an axis of rotation and a substantially annular magnetic ring positioned between the rotor core and the stator. At least two permanent magnets are associated with the magnetic ring, the permanent magnets spaced apart from one another by a gap and oriented substantially parallel to the axis of rotation, the permanent magnets having outer surfaces separated from the coils by the air gap. The magnetic ring is configured to provide a magnetic path for the magnetic fields of the permanent magnets repelled by the rotor core in a direction away from the rotor core so as to focus the magnetic fields of the permanent magnets toward the stator. The permanent magnets may be rare-earth permanent magnets and may be configured to operate as the primary power source for the electric motor. The permanent magnets may be at least partially embedded into the magnetic ring, and the outer surfaces of the permanent magnets may be substantially flush with a radial surface of the magnetic ring.

In some exemplary embodiments, a rotor assembly for an electric motor or generator according to the inventive concepts disclosed herein may include a substantially cylindrical rotor core constructed of a diamagnetic material and having an axis of rotation, and a substantially annular magnetic ring constructed of a magnetic material connected to the rotor core and having a substantially arcuate radial surface oriented substantially parallel to the axis of rotation. At least two permanent magnets may be associated with the magnetic ring so that the permanent magnets are separated at a distance from one another, each of the permanent magnets having an outer surface oriented substantially parallel to the axis of rotation along the substantially arcuate radial surface of the magnetic ring, adjacent outer surfaces having alternating polarities. The magnetic ring is configured to function as a magnetic return path to direct the magnetic fields of the permanent magnets away from the rotor core. The permanent magnets may be connected to the radial surface of the magnetic ring or may be at least partially embedded in the radial surface of the magnetic ring. The permanent magnets can also be substantially completely embedded in the radial surface of the magnetic ring so that the outer surfaces of the permanent magnets are substantially level with the radial surface of the magnetic ring. The permanent magnets can be rare-earth magnets. The magnetic ring can be constructed of a laminated magnetic material.

In some exemplary embodiments, a permanent magnet electric motor according to the inventive concepts disclosed herein may have a rotor assembly which includes a substantially cylindrical rotor core constructed of a diamagnetic material and having an axis of rotation. The electric motor also has a magnetic ring constructed of a magnetic material having a first surface connected to the rotor core and having a substantially arcuate radial surface oriented substantially parallel to the axis of rotation. At least two permanent magnets are associated with the radial surface of the magnetic ring so that the permanent magnets are separated at a distance from one another, each of the permanent magnets having an outer surface oriented substantially parallel to the axis of rotation along the substantially arcuate radial surface of the magnetic ring, adjacent outer surfaces having alternating polarities. The magnetic ring is configured to function as a magnetic return path to direct the magnetic fields of the permanent magnets away from the rotor core. The motor also has a diamagnetic shaft extending through the rotor core substantially coaxially with the axis of rotation. The motor further has a stator assembly, including a stator core rotatably connected to the shaft and at least two coils associated with the stator core so that the coils are positioned circumferentially and coaxially with the outer surfaces of the permanent magnets, and so that the coils are separated from the permanent magnets at a distance such that the coils and the permanent magnets cooperate to define an air gap.

Further, in some exemplary embodiments electric motors according to the inventive concepts disclosed herein may be operated as electromagnetic generators by providing mechanical energy to the rotor, as will be appreciated by persons of ordinary skill in the art.

### BRIEF DESCRIPTION OF THE DRAWINGS

FIG. 1 is a partially cutaway, elevational view of an electric motor constructed in accordance with the inventive concepts disclosed herein.

FIG. 2 is a cross-sectional view of a stator assembly and a rotor assembly of the electric motor of FIG. 1.

FIG. 3 is an enlarged cross-sectional view of a portion of the stator assembly and the rotor assembly.

FIG. 4 is an enlarged cross-sectional view of a portion of the rotor assembly.

FIG. 5 is a diagrammatic view illustrating magnetic flux path of the electric motor.

FIG. 6 is a cross-sectional view of another embodiment of an electric motor constructed in accordance with the inventive concepts disclosed herein.

### DETAILED DESCRIPTION OF EXEMPLARY EMBODIMENTS

Before explaining at least one embodiment of the inventive concepts disclosed herein in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

Referring to the drawings, and more particularly to FIGS. 1-3, an exemplary embodiment of an electric motor 100 according to the inventive concepts disclosed includes a stator assembly 102, a rotor assembly 104, and a control system 106. An external housing 108 may be implemented to house the various components of the electric motor 100 and to protect the various components from dirt, moisture, damage, and other environmental hazards, for example.

The stator assembly 102 includes a stator core 110 and one or more coils 112 arranged in the stator core 110. The stator core 110 may be substantially annular in shape and may be constructed of any desired material, such as metals, composites, ceramics, alloys, polymers, diamagnetic materials, laminated material, magnetic materials, and combinations thereof, for example. The stator core 110 may define a substantially cylindrical opening therethrough to receive the rotor assembly 104 therein so that the stator assembly 102 and the rotor assembly 104 are spaced a distance from one another so as to define an air gap 116 (best shown in FIG. 3). The air gap 116 may have any desired size and is desirably as small as possible to increase the efficiency of the electric motor 100.

The coils 112 may be implemented as any suitable armature windings and may be associated with the stator core 110, in any desired manner, such as by being wrapped around the stator core 110 in series, lap, or as mush windings, for example. In some exemplary embodiments, any desired number of coils 112 may be used, such as thirty-six, or any other desired number. The coils 112 may be separated from one another by feet 113 of the stator core 110, for example. In one exemplary embodiment, where the electric motor 100 is operated as a three-phase electric motor 100, the coils 112 may be controlled by the control system 106 so that three-phase control and/or power signals are provided sequentially to the coils 112, as will be appreciated by a person of ordinary skill in the art.

Referring now to FIGS. 1-4, the rotor assembly 104 includes a rotor core 118, a shaft 120, a magnetic ring 122, and a plurality of permanent magnets 124a-n. The rotor core 118 is substantially cylindrical in shape, and is desirably constructed of a suitable diamagnetic material, such as polymers, ceramics, aluminum, diamagnetic steel, polymers, ceramics, diamagnetic metals, diamagnetic alloys, and combinations thereof. However, in some embodiments, it may be desirable to construct the rotor core 118 from a magnetic material. The rotor core 118 may have any desired diameter or size, for example.

The shaft 120 is shown as a substantially cylindrical shaft 120 extending substantially through the center of the rotor core 118. The shaft 120 may be associated with the rotor core 118 in any desired manner, such as by being press-fitted, welded, glued, bolted, or otherwise attached to the rotor core 118. In some exemplary embodiments, the shaft 120 and the rotor core 118 may be formed as a unitary component. The shaft 120 is desirably constructed of a suitable diamagnetic material having sufficient strength to withstand the torque outputted by the electric motor 100, such as aluminum, diamagnetic steel, polymers, ceramics, diamagnetic metals, diamagnetic alloys, and combinations thereof.

The shaft 120 defines an axis about which the rotor assembly 104 rotates. As shown in FIG. 1, the shaft 120 may be rotatably connected to the housing 108 and/or to the stator assembly 102, for example. One or more optional bearings (not shown), such as ball bearings or magnetic bearings may be implemented to rotatably connect the shaft 120 with the housing 108 and/or the stator assembly 102, as will be appreciated by a person of ordinary skill in the art.

The magnetic ring 122 is substantially annular in shape and is constructed of a suitable magnetic or ferromagnetic material, such as laminated steel or iron, magnetic steel, magnetic iron, magnetic metals, magnetic alloys, and combinations thereof, for example. The magnetic ring 122 has a thickness T (FIG. 4) which may be by way of example about 1.25 inches, or any desired thickness, to cooperate with the magnetic ring 122 in such a way that the magnetic flux of the permanent magnets 124a-n is focused toward the coils 112, as will be described below. The magnetic ring 122 has an inner peripheral surface 126 associated with the rotor core 118 and an outer peripheral surface 128. The magnetic ring 122 may be associated with the rotor core 118 in any desired manner, such as by being wound around the rotor core 118, or by being connected with the rotor core 118 via welds, joints, bolts, adhesives, press-fitted, and combinations thereof, for example.

The permanent magnets 124a-n may be associated with the magnetic ring 122 in any desired fashion such that the permanent magnets 124a-n are in magnetic communication with the magnetic ring 122. In one embodiment, the permanent magnets 124a-n have radial outward surfaces 130 (e.g., substantially arcuate outer surfaces) which are exposed to cooperate with the outer peripheral surface 128 of the magnetic ring 122 to define the air gap 116. The permanent magnets 124a-n may be associated with the magnetic ring 122 by being at least partially or substantially completely embedded in the outer peripheral surface 128, and secured thereto by using bolts, welds, brackets, adhesives, joints, flanges, and combinations thereof, to associate the permanent magnets 124a-n and the magnetic ring 122, for example.

It is to be understood that while the permanent magnets 124a-n are shown as being embedded into the outer peripheral surface 128 of the magnetic ring 122 so that the radial outward surface 130 of each of the permanent magnets 124a-n is substantially flush with the outer peripheral surface 128 of the magnetic ring 122. However, in some exemplary embodiments, the radial outward surface 130 of the permanent magnets 124a-n may be set below or above the outer peripheral surface 128 of the magnetic ring 122, for example.

The permanent magnets 124a-n may be implemented as any desired permanent magnets, such as rare-earth type or lanthanide-type magnets, or any other strong permanent magnets. For example, the permanent magnets 124a-n may include samarium-cobalt magnets and/or neodymium-iron-boron (NIB) magnets. The permanent magnets 124a-n may have any desired shape, size, and orientation. For example, the permanent magnets 124a-n may be oriented substantially parallel to one another and to the axis along the outer peripheral surface 128 of the magnetic ring 122, and may have a thickness of about 0.25 inches, or any other desired thickness. The permanent magnets 124a-n are shown as being substantially rectangular in shape and as being oriented substantially parallel to the axis, but it is to be understood that the permanent magnets 124a-n may have any desired sizes, shapes and orientation, including having a first permanent magnet 124a having a first size, shape, or orientation, and a second permanent magnet 124b having a second size, shape, or orientation, for example. The permanent magnets 124a-n may be substantially rectangular, or may be arcuate in shape, for example.

In the exemplary embodiment, the rotor assembly 104 has thirty-six permanent magnets 124a-n substantially equally spaced around the magnetic ring 122. The stator assembly 102 may have thirty-six coils 112 separated from the thirty-six permanent magnets 124a-n by the air gap 116, for example. As illustrated in FIG. 4, the permanent magnets 124a-n are arranged so that half of the permanent magnets 124a-n have their north (N) pole on the radial outward surface 130 facing the air gap 116, and the other half of the permanent magnets 124a-n have their south (S) pole on the radial outward surface 130 facing the air gap 116, with adjacent magnets having the same orientation, except where the first N-facing half and the S-facing half meet. This orientation will result in a dual-pole orientation of the permanent magnets 124a-n, and therefore a dial-pole operation of the electric motor 100 as will be readily appreciated by a person of ordinary skill in the art. It is to be understood, however, that in some embodiments, adjacent alternating magnets 124a-n may have alternating poles facing the air gap 116, resulting in a multi-pole arrangement of the permanent magnets 124a-n, and multi-pole operation of the electric motor 100. Further, in some exemplary embodiments, alternating quarters of the 36 permanent magnets 124a-n may have alternating poles facing the air gap 116, resulting in a four-pole orientation of the permanent magnets 124a-n, and a four-pole operation of the electric motor 100.

The permanent magnets 124a-n are shown as being separated laterally from one another by gaps 132, which are shown as having a width W (e.g., about 0.29 inches) which may be any desired width, depending on the strength of the permanent magnets 124a-n used, the thickness and diameter of the magnetic ring 122, and/or the diameter of the rotor core 118, for example. Further, while the permanent magnets 124a-n are shown as being spaced a substantially equidistance from one another, in some exemplary embodiments the width of the gap 132 between a first magnet 124a and a second magnet 124b may be different from the width of the gap 132 between the second magnet 124b and a third magnet 124c.

The control system 106 (FIG. 1) can be implemented as any suitable device or group of devices (e.g., one or more of a switch, a relay, a capacitor, a circuit-breaker, a sensor, a contactor, a starter, and combinations thereof) that function to control the electric motor 100 according to the inventive concepts disclosed herein, and may include manual and/or automatic devices for starting and stopping the electric motor 100, controlling the direction and speed of rotation of the electric motor 100, regulating the torque output of the electric motor 100, and combinations thereof. In an exemplary embodiment, the control system 106 may be configured for three-phase control of the coils 112, such as by providing a three-phase control signal to the coils 112. It is to be understood that in some exemplary embodiments, a two-phase, or more than three-phase control signals may be provided to the coils 112 by the control system 106. The amount of current provided to the coils 112 may be any desired amount.

The housing 108 may be constructed of any desired material, such as a diamagnetic metal, alloy, or other diamagnetic material, for example. In some exemplary embodiments, the housing 108 may functions as a heat sink as will be appreciated by persons of ordinary skill in the art, while in some embodiments, the housing 108 may be omitted.

In operation, the electric motor 100 according to the inventive concepts disclosed herein may operate as follows. A relatively low current (e.g., about 0.5 watts, or 6 V times 0.08333 A) is provided to the coils 112 by the control system 106. The relatively low current creates weak magnetic fields in the coils 112 which are less than the magnetic fields of the permanent magnets 124-n and which weak magnetic fields may be switched by the control system 106 to provide three-phase operation of the electric motor 100. The weak magnetic fields in the coils 112 attract the respective magnetic poles of the radial outward surfaces 130 of the permanent magnets 124a-n of the rotor assembly 104 causing the rotor assembly 104 to rotate relative to the stator assembly 102, for example.

The rotor core 118 repels the magnetic flux of the permanent magnets 124a-n. The magnetic ring 122 cooperates with the rotor core 118 to carry and focus the magnetic flux of the permanent magnets 124a-n, including that portion of the magnetic flux repelled by the rotor core 118, outward and towards the coils 112. The number and spacing of the permanent magnets 124a-n also serves to focus the magnetic field outward towards the coils 112, as described above, for example. This configuration of the electric motor 100 allows the permanent magnets 124a-n to function as the primary power source of the electric motor 100. The amount of power or current provided to the coils 112 by the control system 106 is low enough so that substantially no electromagnetic flux enters the rotor core 118 as a result. Because of the low amount of current provided to the coils 112, a relatively low amount of resistive heat is generated by the coils 112. In some exemplary embodiments, the rotor core 118, the shaft 120, and/or the housing 108 may operate as heat sinks to dissipate any heat generated by the operation of the electric motor 100, and is some exemplary embodiments no additional cooling mechanisms other than the heat-sink rotor core 118 and housing 108 are used.

The electric motor 100 according to the inventive concepts disclosed herein is configured to focus the power of permanent magnets, such as the magnets 124a-n, and use such power as the primary power source driving the electric motor 100. Embedding the permanent magnets 124a-n in the magnetic ring 122 of the rotor assembly 104 with the radial outward surfaces 130 of the permanent magnets 124a-n exposed to the air gap 116, allows an electric motor 100 according to the inventive concepts disclosed herein to maximize the benefit of the permanent magnets 124a-n. The electric motor 100 may be configured to utilize the permanent magnets 124a-n as the primary power source, so that a relatively low amount of current is provided to the coils 112 and a relatively large amount of power is output by the electric motor 100. For example, as seen in FIG. 5, the magnetic flux of the permanent magnets 124a-n is directed towards the coils 112 by the rotor core 118 so that substantially no magnetic flux enters the rotor core 118. The magnetic ring 122 and the rotor core 118 thus effectively focus the flux path of the permanent magnets 124a-n and maximize their potential to drive the electric motor 100.

The low stator input provided according to the inventive concepts disclosed herein does not interfere with the magnetic output of the permanent magnets 124a-n. Instead, the stator assembly 102 is configured to act as a speed-control device using a three-phase signal as a means of controlling the speed of the rotor assembly 104 and of attracting the magnetic force of the permanent magnets 124a-n in some exemplary embodiments. Low winding (or I²R) losses reduce the heat generated by electric motors 100 according to the inventive concepts disclosed herein. The magnetic ring 122 in which the permanent magnets 124a-n are embedded according to the inventive concepts disclosed herein focuses the flux from the permanent magnets 124a-n outward from the rotor core 118 to interact with the magnetic field of the stator coils 112 and thereby drive the electric motor 100.

Further, an electric motor according to the inventive concepts disclosed herein may be configured for dual polar or multipolar operation, as will be appreciated by persons of ordinary skill in the art having the benefit of the instant disclosure. FIG. 6 illustrates an exemplary embodiment of a dual-pole electric motor 100a according to the inventive concepts disclosed herein. The electric motor 100a may be implemented and function similarly to the electric motor 100, with the exception that the electric motor 100a has two magnets 124a and 124b separated laterally by gaps, rather than a plurality of magnets 124a-n.

As will be appreciated by persons of ordinary skill in the art, electric motors according to the inventive concepts disclosed herein may be operated as generators of electrical energy by supplying rotational energy to the shaft of the electric motors, capturing the resulting current induced in the coils, and allowing such current to flow through an external circuit (not shown). The current may be processed as needed such as via a transformer, for example.

From the above description, it is clear that the inventive concepts disclosed and claimed herein are well adapted to carry out the objects and to attain the advantages mentioned herein, as well as those inherent in the instant inventive concepts. While exemplary embodiments of the inventive concepts have been described for purposes of this disclosure, it will be understood that numerous changes may be made which will readily suggest themselves to those skilled in the art and which are accomplished within the spirit of the inventive concepts disclosed and/or defined in the appended claims.

What is claimed is:

1. An electric motor, comprising:
a stator assembly including a stator core with at least two armature coils arranged on an inner periphery of the stator core; and
a rotor assembly rotatably positioned in the stator assembly and in a spaced apart relationship thereto, the rotor assembly comprising:
a rotor core having a substantially cylindrical shape and being constructed of a diamagnetic material;
a magnetic ring positioned about the rotor core, the magnetic ring having an outer peripheral surface; and
a plurality of permanent magnets positioned in the magnetic ring in such a way that magnetic fields created by the armature coils provide an attractive force which selectively attracts the permanent magnets toward the armature coils so as to impart rotational mechanical energy to the rotor assembly.

2. The electric motor of claim 1, wherein the permanent magnets are exposed to the armature coils.

3. The electric motor of claim 1, wherein the permanent magnets have outer surfaces substantially flush with the outer peripheral surface of the magnetic ring.

4. The electric motor of claim 1, further comprising a shaft extending axially from the rotor core, the shaft constructed of a diamagnetic material.

5. The electric motor of claim 1, further comprising a control system operably coupled with armature windings and configured to provide a predetermined amount of current to the armature windings sufficient to impart rotational mechanical energy to the rotor assembly.

6. The electric motor of claim 5, wherein the predetermined amount of current is about 0.5 watts.

7. The electric motor of claim 5, wherein the predetermined amount of current is about 6 Volts by about 0.08 Amperes.

8. The electric motor of claim 1, wherein the magnetic ring has a thickness sufficient to provide a magnetic path for the magnetic fields of the permanent magnets repelled by the rotor core in a direction away from the rotor core so as to focus the magnetic fields of the permanent magnets toward the stator.

9. The electric motor of claim 1, wherein the thickness is about 1.25 inches.

10. A rotor assembly, comprising:
a substantially cylindrical rotor core constructed of a diamagnetic material and having an axis of rotation;
a magnetic ring constructed of a magnetic material connected to the rotor core and having a substantially arcuate outer peripheral surface oriented substantially parallel to the axis of rotation; and
a plurality of permanent magnets associated with the magnetic ring, each of the permanent magnets having an outer surface oriented substantially parallel to the axis of rotation along the substantially arcuate outer peripheral surface of the magnetic ring, the permanent magnets being separated a distance from one another with adjacent outer surfaces having alternating polarities,
wherein the permanent magnets are in magnetic communication with the magnetic ring such that the magnetic ring provides a magnetic path for the magnetic fields of the permanent magnets repelled by the rotor core in a direction away from the rotor core so as to focus the magnetic fields of the permanent magnets in a radially outward direction relative to the substantially arcuate outer peripheral surface.

11. The rotor assembly of claim 10, wherein the permanent magnets are connected to the substantially arcuate outer peripheral surface of the magnetic ring.

12. The rotor assembly of claim 10, wherein the permanent magnets are at least partially embedded in the magnetic ring.

13. The rotor assembly of claim 10, wherein the permanent magnets are embedded in the magnetic ring such that the outward surfaces of each of the permanent magnets is flush with the substantially arcuate outer peripheral surface of the magnetic ring.

14. The rotor assembly of claim 10, wherein the permanent magnets are rare-earth magnets.

15. The rotor assembly of claim 10, further comprising a shaft extending axially from the rotor core, the shaft constructed of a diamagnetic material.
